(19) United States
(12) Patent Application Publication
(10) Pub. No.: US 2002/0121961 A1
(43) Pub. Date: Sep. 5, 2002

(54) Monitoring entry through doorways

(76) Inventor: Derek Graham Huff, Surrey (GB)

Correspondence Address: CHRISTIE, PARKER & HALE, LLP, 350 WEST COLORADO BOULEVARD, SUITE 500, PASADENA, CA, 91105, US

(21) Appl. No.: 10/009,114

(22) PCT Filed: Apr. 2, 2001
(86) PCT No.: PCT/GB01/01542

(30) Foreign Application Priority Data
Apr. 1, 2000 (GB) 0008037.4

(51) Int. Cl. G07C 9/00

(52) U.S. Cl. 340/5.3; 340/541; 340/567

(57) ABSTRACT

An access control or monitoring system, comprising means for transmitting an electromagnetic signal across a space (Tₓ); means for receiving said signal (Rₓ), the two means being disposed across a doorway in which a door (1) is located; means for using the received signals to monitor access through the doorway, and means for controlling or monitoring the opening, locking or unlocking of the door by said apparatus.

This invention relates to monitoring entries through portals such as doorways. In particular, it relates to an apparatus and method for detecting and monitoring persons entering or exiting through portals.

There are many instances when it is required to monitor and control persons entering through a doorway. Doorways often have an access system in which a person who is authorised to enter that room first has to identify himself and, once adequate identification has been established, the door is opened, or unlocked. The access system may involve an authorised person presenting an access card to a card reader, or may involve fingerprint or retina verification or other means. Usually, an access control system is involved and this logs the person in and sometimes out of an area. This is used not only for security eg for access to a certain room such as a computer room, but also for time and attendance records, payroll. etc.

A problem is that once the door is open an authorised person can be ‘tailgated’ in by another member of staff or worse still an unauthorised person. That is, a second or further persons may follow him through without being noticed by the system. Indeed, politeness is often the worst enemy of security since a person may often ‘hold the door open’ for someone else to pass through, thinking they are doing them a favour, whereas in fact they are allowing an unauthorised person to pass through. Conventional access controlled doors have no way of monitoring this tailgating or the passage of more than one person through a doorway once the door has been released by an access control system.

Another problem is that an authorised person may open the door, but for some reason not pass through. A conventional access control system is likely to assume the person has passed through. This will have bad implications where the system is required for safety or time and attendance reasons to know if a person is ‘in’ or ‘out’.

With conventional systems when someone presents a card or tag to (for instance) a card reader the identification of the card holder is read and verified. Then an output must be produced which will cause the door to be unlocked. This is typically done by means of a relay which is operated momentarily for a fixed time period (1-5 seconds typically). During this time the door is electrically unlocked and may be opened. Usually, if an additional valid card is presented during this ‘unlock time’ the unlock time is simply extended, ie the relay does not perform another ‘open-close’ sequence for the additional card. In a conventional access controlled door situation this does not represent a problem; the door will be opened and both persons can walk through. An ‘anti-tailgate’ system however, needs to know how many persons are authorised to enter or exit. Clearly if the ‘unlock time’ is set short enough (eg 0.5 seconds) it is possible to expect one relay operation cycle per authorised card presented. However, this time period will be too short to be used to directly unlock the door.

The present invention arose in an attempt to provide an improved access and monitoring system which can effectively monitor and/or measure the passage of each person travelling through a doorway.

According to the present invention there is provided an apparatus for detecting and providing indication of ‘tailgating’ through an access controlled portal, comprising means for transmitting and receiving one or more infrared beams across the portal, monitored by an electronic control means electronically disposed between an authorising means and a locking and/or unlocking means associated with the portal.

According to the present invention there is further provided an access control or monitoring system, comprising means for transmitting an electromagnetic signal across a space; means for receiving said signal, the two means being disposed across a doorway in which a door is located; means for using the received signals to monitor access through the doorway, and means for controlling or monitoring the opening, locking or unlocking of the door by said system.

The electromagnetic signal is preferably provided by infrared radiation.

Preferably, a user identification means is provided, such as a card reader for reading a card held by an authorised person; voice recognition apparatus, signature or retina verification or other means for verifying identity from physical features of a person or other means, whereby if an authorised person is identified, the apparatus provides an output signifying that a person has been authorised for access (or egress) and subsequently monitors entry of that person through a doorway, whereby, if entry by a further person is attempted, that is monitored and an alarm signal, for example, generated.

Preferably, the apparatus is interposed, along the electrical communication path of the system, between said user identification means and said means for controlling or monitoring the opening, locking or unlocking of the door.

In this way, the means for receiving the electromagnetic signal that is transmitted across an access space is also adapted to send control signals to the door controlling and monitoring means, or send signals back to the user identification means.

Preferably, the system is adapted to monitor the direction in which access is made and to generate an alarm condition if access is not made in an expected direction.

The system may be used to provide a warning if unauthorised entry is made. Alternatively, or in addition, it may be used to monitor the number (and/or direction) of people passing through a doorway.

The present invention further provides an access monitoring apparatus comprising means for transmitting an electromagnetic signal across a space; means for receiving said signal, and means for using the received signals to control and monitor access across the space, the apparatus being adapted to receive a signal from an authorising means and to provide controlling signals to a locking and/or unlocking means on an access controlled door.

The invention further provides a method of detecting ‘tailgating’ through a doorway, comprising producing an apparatus, as described above, between an authorising means and locking/unlocking means on an access controlled door, and using the apparatus to detect and/or monitor the number of people passing through the door and/or their direction.

Embodiments of the invention will now be described, by way of example only, with reference to the accompanying drawings, in which:

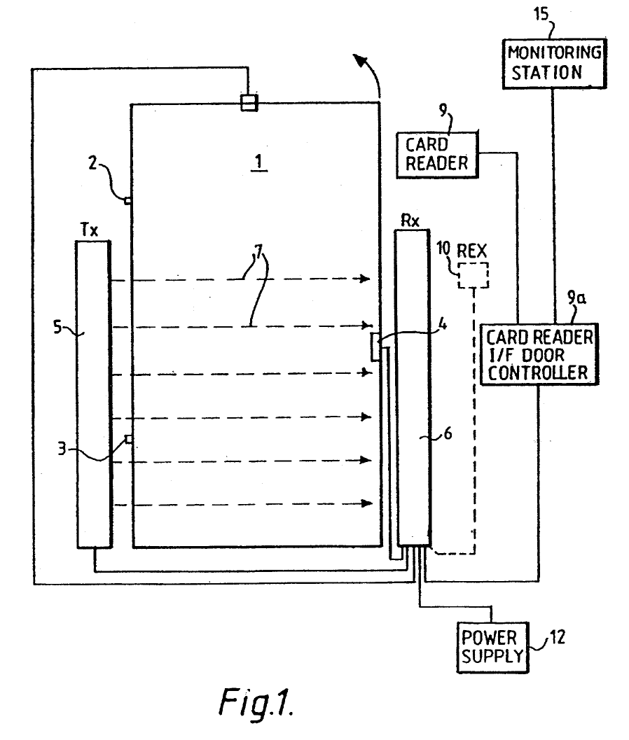

FIG. 1 shows schematically a front view of a door,and access control mechanism;

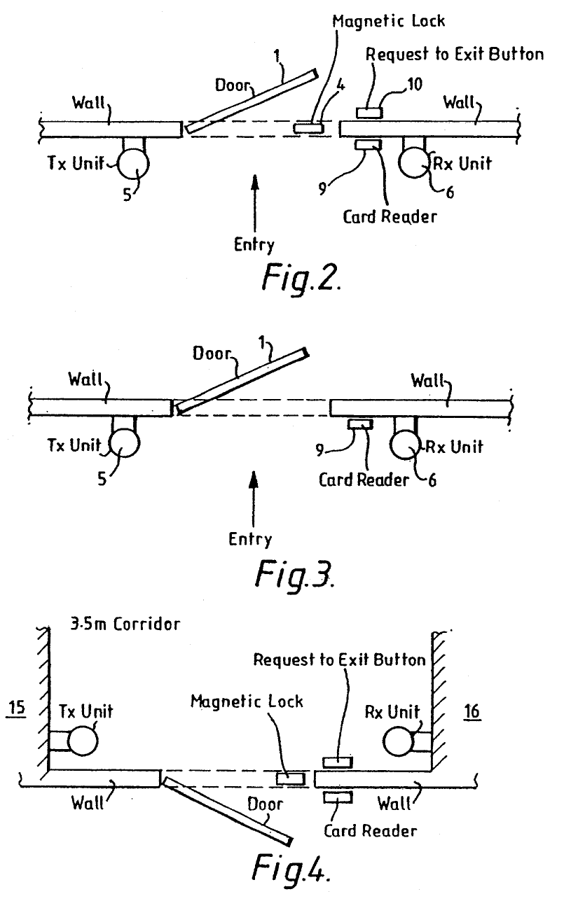

FIG. 2 shows a plan view of a control door,

FIG. 3 shows a plan view of an embodiment but with a monitored door;

FIG. 4 shows a plan view of an embodiment in which transmitting and receiving units are wall mounted; and

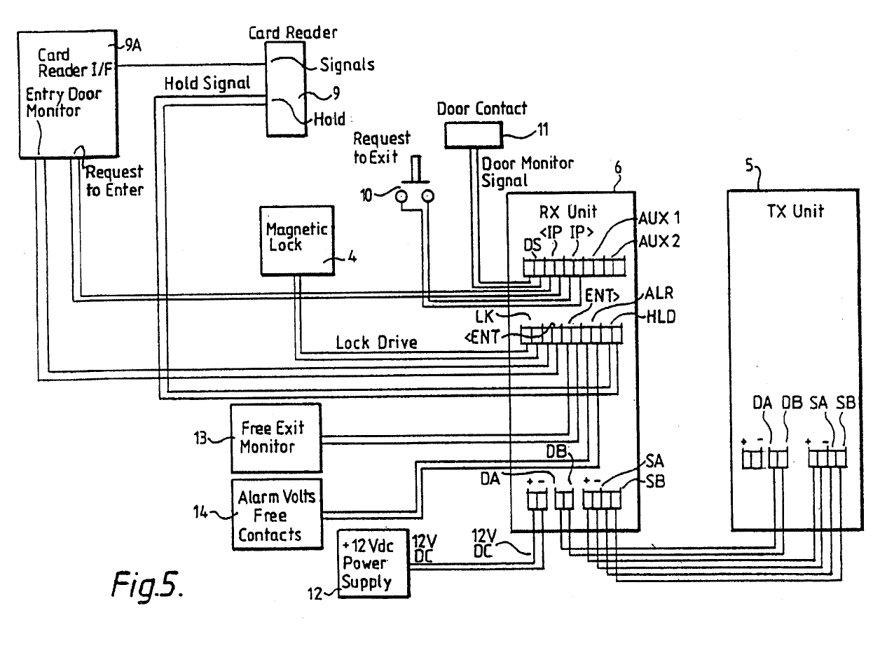

FIG. 5 shows a control and monitoring circuit.

Referring to FIG. 1, there is shown schematically a door I mounted within a doorway. The door is hinged at its left-hand side with hinges 2, 3 and is locked or unlocked by an electromagnetic mechanism 4. The door opens into the plane of the paper. Mounted in front of the doorway are respective transmitting 5 and receiving 6 units for electromagnetic radiation, preferably infrared radiation. These are configured as generally columnar structures, which may, in one example, be approximately 600 mm long and about 70 mm in diameter. Inside transmitting unit 5 are disposed an array of infrared transmitters spaced down its length and receiving unit 6 includes a similar array of co-operating infrared receivers. Thus, a plurality of infrared beams 7 may be transmitted across the face of the doorway as shown.

Other parts of FIG. 1 are described further below.

As is well known in the art, it;is possible to measure the passage of people past infrared beams by detecting when a beam has been broken. It is also possible to accurately determine when a person is being tailgated, either to, ie to indicate that more than one person has passed through a monitored space. By using arrays of beams, and appropriate software, it is known that it is possible to distinguish discrete persons passing through and to account for, for example, trailing arms or legs so that the system can distinguish between a trailing leg of a first person, and the commencement of passage of the second person. This is achieved through the addition of a microprocessor 8a in control apparatus 8, that is adapted to run ‘neural’ type computer programs with weighted input (nodes), summing and logical junctions. In this way, the system can be ‘trained’ to discriminate between people and objects (eg bags, straps, coat tails, etc.) that would otherwise trigger a false alarm. Such networks, and training methods, are known for other types of systems.

FIG. 2 shows a plan view of one method of using the present apparatus. A transmit unit 5 and receiving unit 6 are both mounted to a wall (or may be free-standing) generally in front of a doorway having a door 1. The door is locked or unlocked by a magnetic lock 4 and this is actuated by a card reader 9 on one side and by a request to exit button 10 on the other side of the wall. If the infrared apparatus were not present, then the door would be opened and closed by a user placing his card so that it can be interrogated by the card reader and, upon correct authorisation being established, the magnetic lock 4 would be unlocked. In this embodiment of the present invention, however, the card reader is connected to the control unit 8 (not shown) and in effect the conventional access control system is connected to the control unit as if it were the door and the electrical hardware on the door is connected to the control unit as if it were a conventional access control system. This is shown in FIG. 1 and more clearly in FIG. 5. The card reader 9 is connected by means of a card reader interface unit 9a, sometimes known as a door controller to the receiving unit 6 (it is assumed that the control electronics 8 are incorporated in the receiving unit in this example—they may be housed in separate units). A request to exit (REX) button 10 may also connected to the receiving unit 6 and this operates the magnetic lock 4 and also monitors a door contact sensor 11 so that it can sense independently whether the door is open or closed. The transmitting unit 5 receives power and control signals via the receiving unit 6:. Power is obtained from a power supply, typically a 12 volt DC power supply 12. Further connections are also made to an alarm 14. The apparatus may be connected to a monitoring station 15 which may be a computer and which can log, store or count events or conduct other processing.

Upon an authorised user wishing to gain entry through the door, he presents his card to the card reader 9. The card may be a contact or contactless type or any other type of card and of course it may be replaced by, or be in addition to, any other authorisation system. This may alternatively be a contact from a simple remote button operated by a receptionist for example. Upon correct authorisation being achieved, the card reader interface 9a sends a signal to the receiving unit 6 that one person is permitted to pass through the door. The magnetic lock is then unlocked and, either the door is opened automatically, or the user can push and open the freed door. The infrared system then monitors the passage of one person and closing of the door. In some embodiments, the door may be allowed to open for a certain predefined period before a signal is generated that the door has been ‘held open’. In other embodiments, there may be no set period. The door may be motorised, and could be closed by the system. If a second person tries to enter without having presented his individual authorisation, then the infrared system detects this but knows that only one person has been authorised. It therefore sends a signal to the alarm 14 which generates a suitable alarm, which may be audible, visual, or any other sort of alarm. It may simply indicate on a display that an unauthorised person is entering or has entered. Many other variations will be apparent. If while the door is still open after the first user enters, a second user presents his key and shows that he is authorised then that user will be allowed to pass unhindered and without actuating any alarms.

Sometimes there are situations where a single card reader or means of authorisation is used to allow the passage of persons through a doorway in either direction. In other words, at the point the authorising signal is received the intended direction of passage in or out is not known. The present system can include a mode of operation which allows only the number of persons equalling the number of authorising signals received to use the doorway, and/or pass through in a particular direction.

Optionally, a counter may be used to count and record people who have entered through the doorway and so at any time there can be a log of how many people are in a particular area, or room for example. The card reader may be able to tell the actual identity of the authorised person and so a log can also be made of which specific individuals are in an area. The system may be connected to a central monitoring system (such as a PC) which can indicate all monitored and controlled areas of a building and keep a record of the number of people passing through a particular area with an indication of their direction. The monitoring system may be local or remote, and connected via a telephone or internet link for example.

The numbers of people in certain areas of a building can then be monitored and displayed. When any area approaches a set limit an indication of this can be made. For example an icon on the computer can change colour to warn an operator that the population is nearing the limit. When the limit is reached the icon turns red and a buzzer sounds an alarm.

Indicator lights may be provided, at the apparatus, which in security applications provide flow control for users, eg “present card”, “enter”, “don't enter”, etc. In a counting application, these indicators can be used to show at the door itself when population thresholds are being reached. This has the advantage in a night-club, for instance, that a ‘steward’ at the door does not have to be contacted by the operator of the body count software in order to take action. Indeed, there is less need for an ‘operator’, or in some situations, for a ‘steward’, if people are prepared to obey the indicators.

A further example of this would be for members of the public boarding a vehicle, for example a boat, eg a pleasure cruiser on the Thames. This, device could be used to provide an automatic warning that the safe number of passengers was being approached or had been exceeded. Other applications, where only a certain safe number of people are allowed to enter an area, will be apparent.

An advantageous result of the counter feature of the present system is that the number of authorisations issued for a given monitored area are recorded sequentially. Thus, any out of sequence movements can be detected, triggering an alarm, for example, if necessary.

When a person wishes to exit a space, a request to exit button 10 is provided. Generally, a user only needs to present a card in passing one way through a door. Thus, to exit, he simply needs to press the request to exit button and the system then opens the door and again monitors the person passing through.

It is well known that it is possible to monitor the direction of people passing through infrared beams, with suitable software. Thus, the system can also check that a person is moving in the direction they are expected to be moving. So if a person actuates the card reader and wishes to obtain entry to the space of FIG. 2, then the system will expect him to move in the entry; direction. If it senses a person moving in the other way, then it will set off an alarm or a suitable signal to a monitoring station, or store data relating to that event. Similarly, when a person wishes to exit, the system will be expecting him to move in the exit direction. In an alternative situation, if a person: actuates the card reader but does not enter or exit, the system will recognise this fact and the aforementioned counter will update its log of people that has entered/exited accordingly.

FIG. 3 shows an alternative scenario adapted for exit from a space. In this case, the doorway does not have a magnetic lock, but a person still has to prove his authority by using a card reader 9 or similar. Although the user can push the door and pass through at any stage, unless he has presented his card reader and shown that one person is authorised to pass through the door, the system will actuate an alarm. A door contact sensor (13) is still useful in such a system to indicate whether the door is open or closed.

FIG. 4 shows a further scenario in which the transmitting and receiving units are mounted on side walls 15, 16 of a corridor. Apart from this, the system has a similar function to the embodiment of FIG. 2.

A door contact sensor 11 can monitor whether a door is being held open, for extra security. Also, where it is not possible to reduce the ‘unlock time’ of the door sufficiently to ensure only one complete authorising signal per valid card actuation, the system may provide an output from the control apparatus that disables the card reader from further authorisations until the previous authorising cycle is complete. That is to say, no further authorisation signals can be sent until the system has registered the passage of the previous user. In this way it is possible to ensure that the system correctly keeps count of each authorisation signal.

1. An apparatus for detecting and providing indication of ‘tailgating’ through an access controlled portal, comprising means for transmitting and receiving one or more infrared beams across the portal, monitored by an electronic control means electronically disposed between an authorising means and a locking and/or unlocking means associated with the portal.

2. An access control or monitoring system, comprising means for transmitting an electromagnetic radiation across a space; means for receiving said radiation, the two means being disposed across a doorway in which a door is located; means for using the received signals to monitor access through the doorway, and means for controlling or monitoring the opening, locking or unlocking of the door by said apparatus.

3. An access control or monitoring system as claimed in claim 1 or 2, wherein a user identification means is provided, whereby if an authorised person is identified, the apparatus causes the door to open or be unlocked and subsequently monitors entry of that person through a doorway, whereby, if entry by a further person who is not authorised is attempted, that event is monitored.

4. A system as claimed in claim 3, wherein the user identification means is a card reader, means for verifying identity from physical features of a person, or voice recognition apparatus.

5. A system as claimed in claim 3 or 4, wherein an alarm signal is generated if entry by a further person is attempted.

6. An access control or monitoring system as claimed in any preceding claim, wherein the means for receiving said radiation, or using the received signal, is interposed, along the electrical communication path of the system, between said user identification means and said means for controlling or monitoring the opening, locking or unlocking of the door.

7. An access control or monitoring system as claimed in any preceding claim, wherein the system is adapted to monitor the direction in which access is made and to generate an alarm condition, or monitor an event, if access is not made in an expected direction.

8. An access control or monitoring system as claimed in any preceding claim, wherein the transmitted electromagnetic signal is an infrared signal.

9. A system as claimed in any preceding claim, including means for communicating and/or recording numbers of people entering into, leaving or located within a space or room.

10. A system as claimed in any preceding claim, including means for noting if authorisation is obtained for a person to pass, but then no passage occurs.

11. An access monitoring apparatus comprising means for transmitting an electromagnetic signal across a space; means for receiving said signal, and means for using the received signals to control and monitor access across the space, the apparatus being adapted to receive a signal from an authorising means and to provide controlling signals to a locking and/or unlocking means on an access controlled portal.

12. Apparatus as claimed in claim 11, including means for monitoring the direction of passage of a user.

13. Apparatus as claimed in claim 11 or 12, wherein the electromagnetic signal is an infrared signal.

14. Apparatus as claimed in any preceding claim, wherein the electromagnetic signal comprises a plurality of spaced apart electromagnetic beams.

15. A method of detecting ‘tailgating’ through a doorway, comprising providing an apparatus as claimed in claim 1, or any of claims 11 to 14, between an authorising means and locking/unlocking means on an access controlled door, and using the apparatus to detect and/or monitor the number of people passing through the door and/or their direction.

16. A method as claimed in claim 15, wherein when a user is correctly authorised, the apparatus monitors the passage of that user and logs and/or generates an alarm, if additional persons pass who have not been authorised.
